(19) United States
(12) Patent Application Publication
(10) Pub. No.: US 2004/0258190 A1
(43) Pub. Date: Dec. 23, 2004

(54) Device to perform visual inspection and in-vessel maintenance on vessel components in a nuclear boiling water reactor vessel

(76) Inventor: David Matthew Neau, Oakley, CA (US)

Correspondence Address: David Matthew Neau, 193 Century Way, Oakley, CA, 94561, US

(21) Appl. No.: 10/601,420

(22) Filed: Jun. 23, 2003

(51) Int. Cl. G21C 17/00

(52) U.S. Cl. 376/249

(57) ABSTRACT

A visual inspection device configured to traverse a steam dam around a perimeter of a nuclear boiling water reactor vessel and support a camera for performing visual inspections. The device includes a trolley having at least two roller assemblies coupled by a connecting member. The roller assemblies steer the trolley around the perimeter of the reactor vessel. At least one of the roller assemblies is driven by a first motor. The device also includes a mast upstanding from the trolley, an elevating mechanism coupled to the mast, a carriage coupled to the mast and the elevating mechanism, the carriage being responsive to activation of the elevating mechanism for movement relative to and along the mast, a first arm rotatably coupled at a first end to the carriage, and a second arm rotatably coupled to a second end of the first arm, the camera being supported by the second arm.

### FIELD OF THE INVENTION

This invention relates generally to devices used in the boiling water reactor industry, and more specifically to devices that perform maintenance on vessel components.

### BACKGROUND OF THE INVENTION

In the boiling water reactor industry, the reactor is a pressure vessel where the nuclear reaction takes place. The nuclear reaction generates heat, which boils water to create steam; the steam then powers turbines to generate electricity. In the reactor, welds are inspected for cracks while in-vessel components are also inspected for wear. This is called In-Vessel Visual Inspections (“IVVI”). The reactor is disassembled for refueling outages and in-vessel servicing takes place at this time. Typically, the following components and welds are inspected during in-vessel servicing:

Feedwater spargers & nozzle welds

Feedwater end brackets & T-Box welds

Feedwater nozzle penetrations

Core spray piping & downcomers

Core spray spargers & T-Box welds

Core spray brackets & end caps

Top guide hold down bolts

Shroud welds

Jet pump assembly

Nozzle penetrations

Baffle plate inspection

Core verification

Fuel spotting support

In-vessel maintenance is also performed during the refueling outage. Examples of in-vessel maintenance include:

Nozzle flushing

Lost parts retrieval

Weld cleaning

Underwater vacuuming

### SUMMARY OF THE INVENTION

In the past, contractors have performed IVVI for the utility industry. The basic practice has been to use a hand-held underwater camera system from the refueling bridge. This practice required the sole use of the refueling bridge by the contractors, which delayed moving fuel into the reactor core. This practice also extended the duration of the refueling outage. Any lost time on the critical path (the amount of time between shut down and start-up of the reactor) costs the utility company large amounts of money. Camera systems have been improved for better performance, but inspection time was still required. Eventually, the industry began to use an auxiliary bridge and two IVVI teams to help decrease the duration of the refueling outage. This increased the cost of the outage, but saved millions of dollars by shortening refueling outages from 90 days to 30 days.

Certain time windows must be placed on the refueling schedule. One of those windows is refueling the reactor core with new fuel bundles. This task requires the sole use of the refueling bridge. Any work that can be performed while fuel movement is taking place gains time on the critical path. All previous attempts to do this have failed. Some have attempted to perform IVVI from an aluminum boat while moving fuel; this was deemed an unsafe work practice and has never been attempted since. Therefore, a need exists in the industry for a device that performs IVVI while moving fuel into the reactor core. This device also needs to be self-contained so that set-up and tear down times are minimized. Each construction of the present invention fulfills one or more of these needs.

Th present invention provides a device that addresses some of the needs of the boiling water reactor industry and the shortcomings of prior art. The present invention is a delivery device for an underwater camera system that performs visual inspection and maintenance of welds and reactor components while traversing a nuclear reactor vessel. Since the vessel is filled with water, the device must operate underwater to perform the visual inspection and maintenance. IVVI can be performed remotely by the device while refueling the reactor. The preferred device comprises a trolley, mast, carriage, swing arm, and support arm. A commonly available pan and tilt camera system is mounted to the carriage through a support arm that rotates about a swing arm. The support arm is rotatable between a standard and inverted position. The swing arm swivels off the carriage to allow the camera system to rotate about an axis parallel to an axis defining the mast length. The carriage moves vertically on the mast that is centrally mounted on the trolley. The trolley rolls around the steam dam, which is essentially the perimeter of the reactor vessel. The steam dam is circular and is used as a track to guide the device to different azimuths for inspections or maintenance.

Since the device can be controlled remotely, IVVI can be performed while moving fuel into the reactor core. The device is also self-contained so that set-up and tear down times are minimized. Further features and aspects of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show preferred constructions of the present invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the present invention.

In the drawings, wherein like reference numerals indicate like parts:

FIG. 1 is a perspective view of a delivery device embodying the present invention showing a camera system in a standard position with an attached vacuum hose;

FIG. 2 is an enlarged view of a carriage of the delivery device of FIG. 1;

FIG. 3 is a perspective view of the delivery device of FIG. 1 showing the camera system in an inverted position with an attached water lance;

FIG. 4 is a perspective view of a trolley;

FIG. 5 is a front view of the trolley of FIG. 4;

FIG. 6 is a partial perspective view of a mast including a lead screw and electric motor;

FIG. 7 is a front view of the mast of FIG. 6;

FIG. 8 is a top view of the mast of FIG. 6;

FIG. 9 is a perspective view of a carriage with portions removed;

FIG. 10 is a front view of the carriage of FIG. 9 with portions removed;

FIG. 11 is a top view of the carriage of FIG. 9 mounted to the mast;

FIG. 12 is a side view of the delivery device of FIG. 1 mounted to the reactor steam dam; and

FIG. 13 is a front view of the delivery device of FIG. 12 mounted to the reactor steam dam.

### DETAILED DESCRIPTION

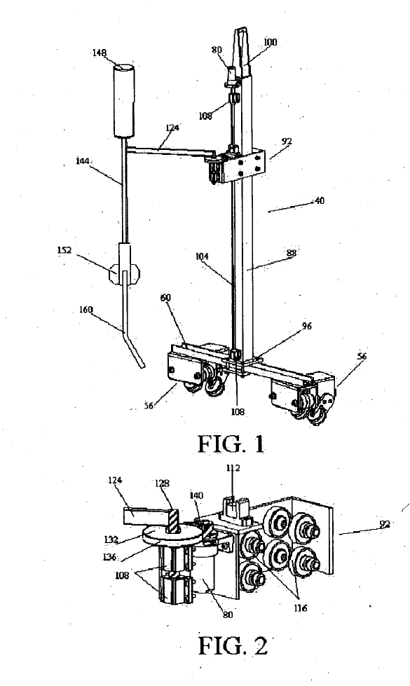

With reference to FIG. 1, the present invention comprises a delivery device 40 that traverses the perimeter of a circular steam dam 44, which acts as a track around the perimeter of the vessel 48. A trolley 52 provides the propulsion for the delivery device 40 and includes two roller assemblies 56 coupled by a connecting member 60. Each roller assembly 56 includes a combination of steam dam rollers 64 and shroud flange rollers 68. The steam dam rollers 64 utilize a v-notch 72 to assist in centering the trolley 52 on the steam dam 44. The shroud flange rollers 68 also utilize a v-notch 72 to assist in centering the trolley 52 on the shroud flange 76. In the illustrated construction, each roller assembly 56 includes two steam dam rollers 64 and two shroud flange rollers 68. Two roller assemblies 56 are utilized in the illustrated construction, each assembly 56 being located at opposite ends of the trolley 52. Both roller assemblies 56 utilize a 24-volt DC high torque, low speed electric motor 80 capable of both clockwise and counter-clockwise rotation. Torque is transmitted from the motor 80 to the steam dam rollers 64 through a rubber belt 84. As a result, in the illustrated construction, all four steam dam rollers 64 on the trolley 52 are powered while the remaining shroud flange rollers 68 are not powered.

In another construction (not shown), the roller assemblies 56 can utilize multiple combinations of steam dam rollers 64 and shroud flange rollers 68. For example, each roller assembly 56 can utilize more or less than four rollers.

In yet another construction (not shown), the roller assemblies 56 can be configured to power the shroud flange rollers 68 rather than the steam dam rollers 64. In addition, only one of the roller assemblies 56 can be configured to propel the trolley 52.

In the illustrated construction, the roller assemblies 56 are rigidly coupled to the connecting member 60 using ordinary fasteners. Each roller assembly 56 is coupled at an angle relative to the connecting member 60. As a result, the trolley 52 traverses an arc of a predetermined radius.

In another construction (not shown), the roller assemblies 56 can be pivotally coupled to the connecting member 60 to allow the trolley 52 to traverse an arc of virtually any radius. Using this configuration, the trolley 52 could also traverse an arc having a varying radius rather than a constant radius.

With reference to FIGS. 1 & 3, a mast 88 provides a vertical guide for a carriage 92. In the illustrated construction, the mast 88 is centrally mounted on the trolley 52 and attached through a base plate 96 using common fasteners. To help minimize component weight, the mast 88 may be constructed using aluminum square tubing. The mast 88 also has a handle 100 used for installation and removal.

In the illustrated construction, an elevating mechanism in the form of a lead screw 104 spanning the entire length of the mast 88 is mounted to one side of the mast 88. The lead screw 104 is mounted to the mast 88 by two pillow blocks 108 positioned at opposite ends of the mast 88. The elevating mechanism also includes a 24-volt DC high torque, low speed electric motor 80 that directly drives the lead screw 104. The 24-volt DC high torque, low speed electric motor 80 is capable of both clockwise and counter-clockwise rotation.

The lead screw 104 provides vertical movement for the carriage 92. As shown in FIGS. 1-3 & 9-11, the carriage 92 utilizes a threaded member 112 that includes internal threading matched to engage the threading of the lead screw 104. The threaded member 112 is affixed to the carriage 92 such that rotation of the lead screw 104 results in vertical movement of the carriage 92 on the mast 88. A series of rollers 116 guide the carriage 92 along the mast 88. The rollers 116 are configured such that the mast 88 is disposed between two sets of four rollers 116. The rollers 116 are mounted to opposing walls of a box structure 120 that fits entirely around the mast 88. Alternatively, the rollers 116 can be configured in any way such that the carriage 92 traverses in a stable manner along the mast 88.

In another construction (Appendix), the carriage 92 ascends or descends the mast 88 using the 24-volt DC high torque, low speed electric motor 80 coupled to a spur gear (Appendix) that engages a rack (Appendix). The electric motor 80 can be mounted on the carriage 92 towards one side of the mast 88. The electric motor 80 is positioned on the carriage 92 such that a spur gear coupled to the electric motor 80 engages the rack. Torque applied by the electric motor 80 to the spur gear results in a vertical movement of the carriage 92.

In yet another construction (not shown), the carriage 92 can utilize powered rollers 116 to provide vertical movement for the carriage 92. The rollers 116 can be driven by another 24-volt high torque, low speed electric motor 80 through a belt (not shown) similar to the arrangement used in the trolley 52. The rollers 116 can include a sticky surface to maintain traction along the mast 88. Alternatively, treads (not shown) can be wrapped around a configuration of rollers 116 (similar to a tank tread configuration) to provide additional grip to the mast 88.

In the illustrated construction, another 24-volt DC high torque, low speed electric motor 80 is mounted on the carriage 92. This motor 80 is also capable of clockwise and counter-clockwise rotation. This electric motor 80 swivels a swing arm 124 off the carriage 92. The swing arm 124 is mounted to the carriage 92 by two pillow blocks 108 that support an intermediate shaft 128. The intermediate shaft 128 includes a sprocket 132 that is driven by the electric motor 80 through a belt 136. The electric motor 80 drives the belt 136 using another sprocket 140. The sprockets 132, 140 are sized to provide an increase in torque and a decrease in speed to the intermediate shaft 128. The swing arm 124 is mounted to the intermediate shaft 128 at a 90-degree angle such that the swing arm 124 swivels about an axis coaxial with the intermediate shaft 128. The swing arm 124 has the capability of about 270 degrees of rotation.

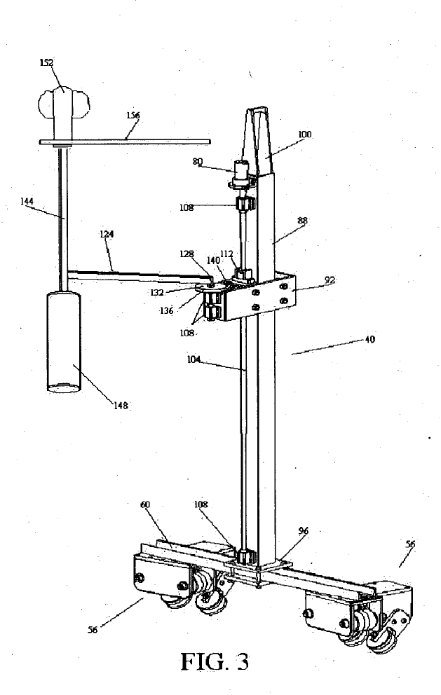

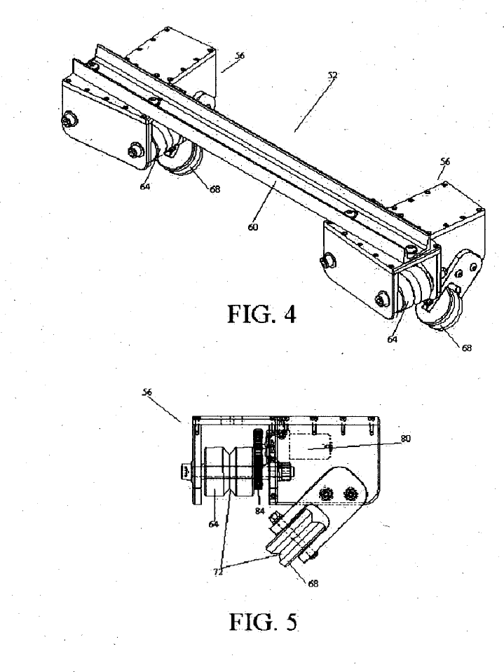

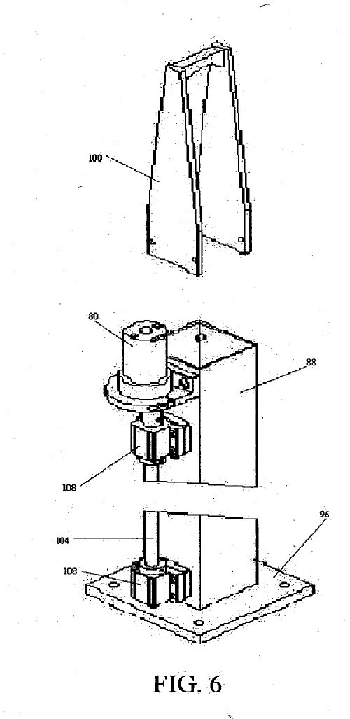

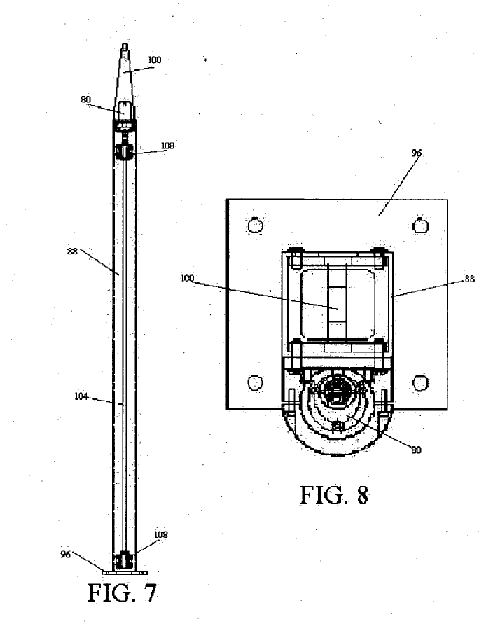

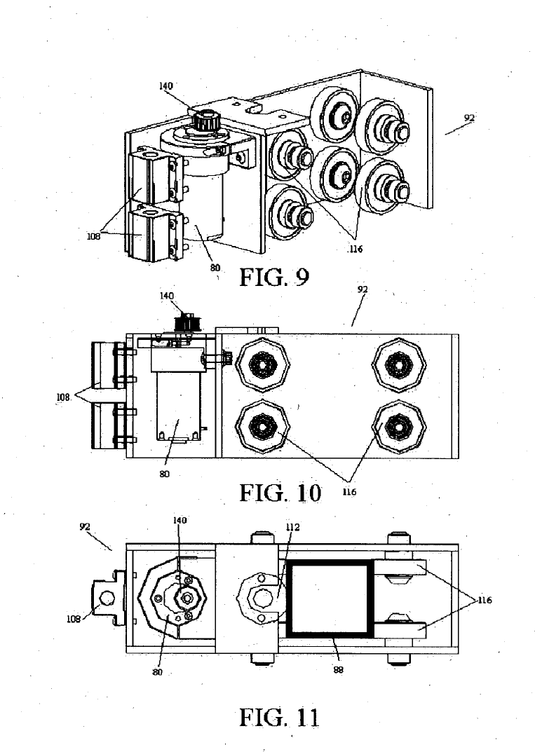

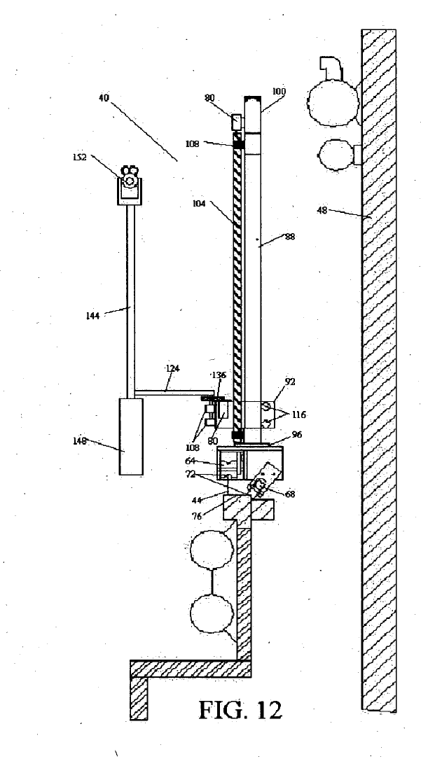

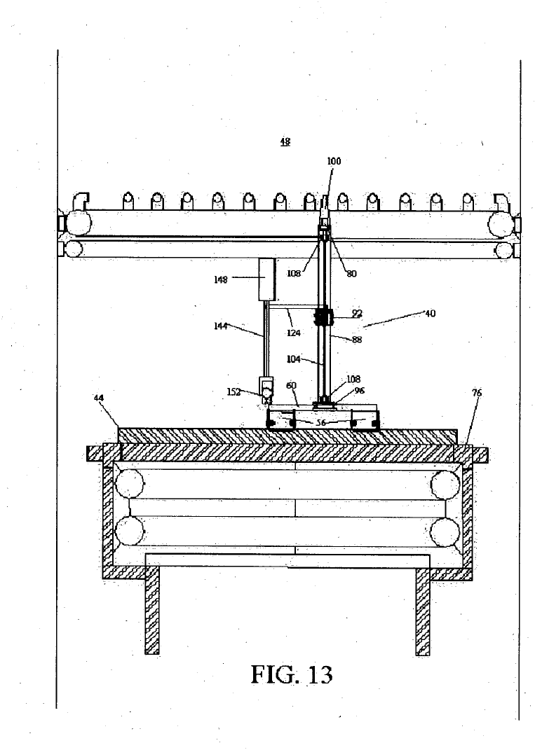

A support arm 144 is mounted to the end of the swing arm 124 by a shoulder bolt (not shown). The support arm 144 is mounted to the swing arm 124 so that it rotates about an axis coaxial with the swing arm 124. A float chamber 148 is mounted towards one end of the support arm 144 while a pan and tilt camera system 152 is mounted towards the other end of the support arm 144. The float chamber 148 is buoyant and is sized to help offset the weight of the camera system 152 acting on the device 40. In the illustrated construction, the support arm 144 is mounted to the swing arm 124 in one of two positions, the standard position or the inverted position. As shown in FIG. 1, the standard position allows the device 40 to perform lower region inspections. The support arm 144 is rotated such that the camera system 152 is positioned towards the bottom of the device 40 and the float chamber 148 positioned towards the top of the device 40. As shown in FIG. 3, the inverted position allows the device 40 to perform upper region inspections. The support arm 144 is rotated such that the camera system 152 is positioned towards the top of the device 40 while the float chamber 148 is positioned towards the bottom. When switching from a lower region inspection (standard position) to an upper region inspection (inverted position), the device 40 is pulled from the vessel 48, the shoulder bolt loosened, the support arm 144 manually rotated, then finally the shoulder bolt is re-tightened to lock the support arm 144 in place.

In another construction (not shown), a commonly available air cylinder (not shown) mounts to the swing arm 124 and connects to the support arm 144. The air cylinder maintains the support arm 144 in a vertical position with respect to the installation of the device 40 on the steam dam 44. The device 40 is installed on the steam dam 44 with the camera system 152 in an upper position with respect to the installation. In the upper position, the air cylinder rod (not shown) is extended. The rod may be retracted to allow the support arm 144 to rotate, thus allowing the float chamber 148 to move to the upper position while the camera 152 moves to a lower position. When the rotation is complete, the rod is extended once again to maintain the support arm 144 in a vertical position with respect to the installation of the device 40 on the steam dam 44.

In yet another construction (not shown), a commonly available 24-volt DC high torque, low speed electric motor 80 including an attached gear (not shown) can mount to the swing arm 124 such that the attached gear engages another gear mounted to the support arm 144. The gear mounted to the support arm 144 can be coaxially mounted with an axis defined by the swing arm 124 such that rotation of the support arm 144 occurs about the swing arm 124. During operation, the device 40 is installed on the steam dam 44 with the camera system 152 in the inverted position. In the inverted position, the electric motor 80 maintains the support arm 144 in a vertical position whereby the camera system 152 is positioned toward the top of the device 40. The electric motor 80 can be energized to rotate the support arm 144, thus moving the float chamber 148 to the upper position while the camera system 152 moves to a lower position. When rotation is completed, the motor 80 is de-energized to maintain the support arm 144 in the standard position.

The device 40 and camera system 152 are controlled remotely from a station (not shown) located on the refueling floor (not shown). An umbilical (not shown) comprising the camera system cable (not shown) and the power cables (not shown) for the device 40 extend from the device 40 to the remote station. Floats (not shown) are attached to the umbilical to keep it buoyant in the water.

In the illustrated construction, additional tooling is utilized to perform in-vessel maintenance. Such tooling may include a water lance 156, an underwater vacuum hose 160, or remote air operated pliers (not shown). The tooling is attached to a remote arm (not shown) that is mounted to the side of the camera system 152. As shown in FIG. 1, an underwater vacuum hose 160 is mounted to the camera system 152, while a water lance 160 is shown mounted to the camera system 152 in FIG. 3. The pan and tilt motion of the camera system 152 allows the tooling to be used on an object in view of the camera system 152. When the tooling is utilized, either a water hose (not shown) or air hose (not shown) is incorporated with the umbilical to provide the water lance 160 with pressurized water, the vacuum hose with vacuum, and the pliers with pressurized air respectively.

I claim:

1. A visual inspection device configured to traverse a steam dam around a perimeter of a nuclear boiling water reactor vessel, the device being adapted to support a camera for performing visual inspections, the device comprising:
a trolley including at least two roller assemblies coupled by a connecting member, the roller assemblies being configured to steer the trolley around the perimeter of the reactor vessel, at least one of the roller assemblies being driven by a first motor;
a mast coupled to and upstanding from the trolley;
an elevating mechanism coupled to the mast;
a carriage coupled to the mast and the elevating mechanism, the carriage being responsive to activation of the elevating mechanism for movement relative to and along the mast;
a first arm rotatably coupled at a first end to the carriage; and
a second arm rotatably coupled to a second end of the first arm, the camera being supported by the second arm.

2. The device of claim 1, wherein the roller assemblies are coupled to the connecting member at an angle relative to the connecting member.

3. The device of claim 1, wherein each roller assembly includes at least two steam dam rollers configured to engage the steam dam.

4. The device of claim 3, wherein at least one of the at least two steam dam rollers is driven by the first motor.

5. The device of claim 3, wherein the roller assemblies each include at least two shroud flange rollers configured to engage a shroud flange of the reactor vessel.

6. The device of claim 1, wherein the elevating mechanism includes a lead screw rotatably coupled to the mast, and a second motor coupled to the mast and drivingly engaged to the lead screw, and wherein the carriage includes a threaded member mounted thereto, the lead screw being threadably engaged with the threaded member such that the carriage is responsive to rotation of the lead screw.

7. The device of claim 1, further comprising a third motor coupled to the carriage for rotating the first arm relative to the carriage.

8. The device of claim 7, wherein the first arm is coupled to the carriage via an intermediate shaft rotatably supported by at least one pillow block mounted to the carriage, and wherein the intermediate shaft is driven by the third motor to rotate the first arm.

9. The device of claim 1, wherein the second arm is rotatably coupled to the first arm in at least one of a first position, in which the camera is positioned below the carriage, and a second position, in which the camera is positioned above the carriage.

10. The device of claim 9, wherein the second arm is selectively fastened to the first arm in one of the first and second positions.

11. The device of claim 1, further comprising a float chamber coupled to the second arm opposite the camera, the float chamber being sized to offset weight of the camera.

12. The device of claim 1, wherein the carnage includes at least two opposing rollers configured to engage opposite sides of the mast.

13. The device of claim 1, further comprising a handle coupled to the mast.

14. A visual inspection device configured to traverse a steam dam around a perimeter of a nuclear boiling water reactor vessel, the device comprising:
a trolley including at least two roller assemblies coupled by a connecting member, the roller assemblies being configured to steer the trolley around the perimeter of the reactor vessel, at least one of the roller assemblies being driven by a first motor;
a mast coupled to and upstanding from the trolley;
a lead screw rotatably coupled to the mast;
a second motor coupled to the mast and drivingly engaged to the lead screw;
a carriage coupled to the mast and threadably coupled to the lead screw, the carriage being responsive to rotation of the lead screw for movement relative to and along the mast;
a first arm rotatably coupled at a first end to the carriage;
a second arm rotatably coupled to a second end of the first arm;
a camera system being supported at one end of the second arm, the camera system being configured for performing visual inspections;
a float chamber coupled to the second arm at an end opposite the camera, the float chamber being sized to offset weight of the camera; and
a tool coupled to the second arm adjacent the camera system.

15. The device of claim 14, wherein the roller assemblies are coupled to the connecting member at an angle relative to the connecting member.

16. The device of claim 14, wherein each roller assembly includes at least two steam dam rollers configured to engage the steam dam.

17. The device of claim 14, wherein the roller assemblies each include at least two shroud flange rollers configured to engage a shroud flange of the reactor vessel.

18. The device of claim 14, wherein the second arm is rotatably coupled to the first arm in at least one of a first position, in which the camera is positioned below the carriage, and a second position, in which the camera is positioned above the carriage.

19. The device of claim 14, wherein the tool is a water lance.

20. The device of claim 14, wherein the tool is a vacuum hose.
